(19) United States
(12) Patent Application Publication
(10) Pub. No.: US 2006/0054864 A1
(43) Pub. Date: Mar. 16, 2006

(54) Method and structure for non-linear optics

(75) Inventors: Theodore Alekel, Corvallis, OR (US); Douglas A. Keszler, Corvallis, OR (US); Ning Ye, Fuzhou (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Deep Photonics Corporation, Corvallis, OR (US)

(21) Appl. No.: 11/107,367

(22) Filed: Apr. 14, 2005

Related U.S. Application Data
(60) Provisional application No. 60/562,881, filed on Apr. 16, 2004.
(60) Provisional application No. 60/562,626, filed on Apr. 14, 2004.

(51) Int. Cl. C09K 11/08

(52) U.S. Cl. 252/301.4 R; 423/263

(57) ABSTRACT

A compound for non-linear optics for use at 350 nm and below. The compound includes a material for non-linear optics comprising AₓM₍₁₋ₓ₎Al₃B₄O₁₂. x is larger than or equal to zero and smaller than or equal to 0.1, A is selected from a group consisting of Sc, Y, La, Yb, and Lu, and M is selected from a group consisting of Sc, Y, La, Yb, and Lu. The compound is free from a molybdenum bearing impurity of at least 1000 parts per million.

### CROSS-REFERENCES TO RELATED APPLICATIONS

This application claims priority to U.S. Provisional Application Nos. 60/562,881 filed Apr. 16, 2004 and 60/562,626 filed Apr. 14, 2004, both of which are incorporated by reference herein.

### STATEMENT AS TO RIGHTS TO INVENTIONS MADE UNDER FEDERALLY SPONSORED RESEARCH OR DEVELOPMENT

This invention was made in part using funds provided by the National Science Foundation Grant No. ECS-0114017. The United States Government may have certain rights in this invention.

### REFERENCE TO A “SEQUENCE LISTING,” A TABLE, OR A COMPUTER PROGRAM LISTING APPENDIX SUBMITTED ON A COMPACT DISK.

Not Applicable

### BACKGROUND OF THE INVENTION

The present invention relates generally to certain compounds having optical properties. More particularly, as an example, the invention provides a specific compound comprising AₓM₍₁₋ₓ₎Al₃B₄O₁₂ for use with selected wavelengths of electromagnetic radiation. x is larger than or equal to zero and smaller than or equal to 0.1, A is selected from a group consisting of Sc, Y, La, Yb, and Lu, and M is selected from a group consisting of Sc, Y, La, Yb, and Lu. Merely by way of example, the compound is useful for electromagnetic radiation having a wavelength of 350 nm and less, but it would be recognized that the invention has a much broader range of applicability.

Nonlinear optical (NLO) materials are unusual in that they affect the properties of light. A well-known example is the polarization of light by certain materials, such as when materials rotate the polarization vectors of absorbed light. If the effect on the polarization vector by the absorbed light is linear, then light emitted by the material has the same frequency as the absorbed light. NLO materials affect the polarization vector of the absorbed light in a nonlinear manner. As a result, the frequency of the light emitted by a nonlinear optical material is affected.

For example, when a beam of coherent light of a given frequency, such as produced by a laser, propagates through a properly oriented NLO crystal having non-zero components of the second order polarizability tensor, the crystal will generate light at a different frequency, thus extending the useful frequency range of the laser. Generation of this light can be ascribed to processes such as sum-frequency generation (SFG), difference-frequency generation (DFG) and optical parametric amplification (OPA). Devices using NLO crystals include, but are not limited to up and down frequency converters, optical parametric oscillators, optical rectifiers, and optical switches.

Frequency generation in NLO materials is usually an important effect. For example, two monochromatic electromagnetic waves with frequencies ω₁ and ω₂ propagating through a properly oriented NLO crystal can result in generation of light at a variety of frequencies. Mechanisms defining the frequency of light using these two separate frequencies are sum-frequency generation (SFG) and difference-frequency generation (DFG). SFG is a process where light of frequency ω₃ is generated as the sum of the two incident frequencies, ω₃=ω₁+ω₂. In other words, SFG is useful for converting long wavelength light to shorter wavelength light (e.g. near infrared to visible, or visible to ultraviolet). A special case of sum-frequency generation is second-harmonic generation (SHG) where ω₃=2ω₁, which is satisfied when the incident frequencies are equal, ω₁=ω₂. DFG is a process where light of frequency ω₄ is generated as the difference of the incident frequencies ω₄=ω₁−ω₂. DFG is useful for converting shorter wavelength light to longer wavelength light (e.g. visible to infrared). A special case of DFG is when ω₁=ω₂, hence ω₄=0, which is known as optical rectification. Optical parametric oscillation (OPO) is also a form of DFG and is used to produce light at tunable frequencies.

The conversion efficiency of an NLO crystal for a particular application is dependent on a number of factors that include, but are not limited to: the effective nonlinearity of the crystal (picometers/volt [pm/V]), birefringence (Δn, where n is a refractive index), phase-matching conditions (Type I, Type II, non-critical, quasi, or critical), angular acceptance angle (radian-cm), temperature acceptance (.degree. K-cm), walk-off (radian), temperature dependent change in refractive index (dn/dT), optical transparency range (nm), and the optical damage threshold (W/cm²). Desirable NLO crystals should posses an optimum combination of the above properties as defined by the specific application.

Borate crystals form a large group of inorganic NLO materials used in various applications, such as laser-based manufacturing, medicine, hardware and instrumentation, communications, and research studies. Beta barium borate (BBO: β-BaB₂O₄), lithium triborate (LBO: LiB₃O₅), and cesium lithium borate (CLBO: CsLi(B₃O₅)₂) are examples of borate-based NLO crystals developed in recent years that are being used widely as NLO devices, especially in high power applications. Select properties suitable for generation of laser light from the mid-infrared to the ultraviolet for these crystals are listed in Table 1.

TABLE 1
Commercially Available NLO Materials and Properties

| PROPERTY | BBO | LBO | CLBO |
|---|---|---|---|
| D_{eff} (pm/V) | 2.2 | 0.8 | 0.9 |
| Optical Transmission (nm) | 190-3500 | 160-2600 | 180-2750 |
| Angular Acceptance (mrad-cm) | 0.8 | 6.5 | 0.6 |
| Temperature Acceptance (K-cm) | 55 | 7.5 | 2.5 |
| Walk-off Angle (deg.) | 3 | 0.6 | 1.8 |
| Damage Threshold (GW/cm²) | 5 | 10 | 10 |
| Crystal Growth Properties | flux or congr. | flux | congruent |

BBO has a favorable non-linearity (about 2.2 pm/V), transparency between 190 nm and 3500 nm, significant birefringence (necessary for phase matching), and a high damage threshold (5 GW/cm², 1064 nm, 0.1 ns pulse width). However, its high birefringence creates a relatively small angular acceptance that can limit conversion efficiencies and laser beam quality. The crystal is relatively difficult to grow to large sizes and is somewhat hygroscopic.

LBO exhibits optical transparency throughout the visible electromagnetic spectrum, extending well into the ultraviolet (absorption edge.congruent. 160 nm), and possesses a high damage threshold (10 GW/cm², 1064 nm, 0.1 ns pulse width). However, it has insufficient intrinsic birefringence for phase matching to generate deep UV radiation. Furthermore, LBO melts incongruently and must be prepared by flux-assisted crystal growth methods. This limits production efficiency that leads to small crystals and higher production costs.

CLBO appears capable of producing UV light due to a combination of high nonlinearity and sufficient birefringence. The crystal can also be manufactured to relatively large dimensions. However, the crystal usually is exceedingly moisture sensitive and often invariably sorbs water from the air; hence, extreme care usually must be taken to manage environmental moisture to prevent hydration stresses and possible crystal destruction.

In 1981 a crystal called NYAB [NdₓY₍₁₋ₓ₎Al₃B₄O₁₂] was reported in the USSR. A laser self-frequency-doubling effect from 1320 nm to 660 nm was realized in a Nd_{0.2}Y_{0.8}Al₃B₄O₁₂ crystal, but it was found that intrinsic crystal absorption at the second harmonic limited practical use of laser self-frequency-doubling from 1060 nm to 530 nm.

Years later several institutes in China succeeded in improving the crystal growing process and obtained NYAB crystals of good optical quality and reasonable size. Lu et al. developed a multi-functional crystal NdₓY₍₁₋ₓ₎Al₃B₄O₁₂ with effective laser self-frequency-doubling conversion. The Nd³⁺ doped laser gain crystal was pumped with a dye laser, with laser emission at 1060 nm that was then converted to 530 nm within itself (see FIG. 2 of Lu et al., Chinese Phys. Lett. Vol. 3, No. 9 (1986)). NYAB has since been used as a research crystal that often is useful only in the visible spectrum. Recent work with Yb-doped YAB as a self-doubling laser gain material follows the same path as NYAB with small alterations in operational laser efficiency and wavelengths. Laser light is generated within the crystal and self-doubled into green 520 nm. (see Dekker et al., JOSA B, Vol. 22, No. 2 (2005) 378-384). Again, its operation and the historic method of preparation limit its use to the visible and infrared. Hence, it is highly desirable to improve techniques for this family of compounds that enable optical function down into the ultraviolet.

In other words, the optical properties of nonlinear optical (NLO) materials are modified by light passing through the materials. The modification of the optical properties may be caused by an induced electronic charge displacement (polarization) that acts as an oscillating dipole. The oscillating dipole may cause the material to emit a photon. When the polarization of the material is linear, the emitted photon has the same frequency as the light incident upon the material. If the polarization is nonlinear, the frequency of the light emerging from the material may be some integer value times the frequency of the incident light. For example, the net effect of frequency doubling is that two photons with a frequency ω combine to generate a single photon having a frequency equal to 2ω. Thus, propagation of the waves in synchronization (phase-matching) allows the light's frequency to double. Frequency doubling also is referred to as second harmonic generation (SHG). NLO materials were discovered to be capable of second harmonic generation in 1961. Ann. Rev. Mater. Sci., 16:203-43 (1986).

Several NLO materials have been recognized in the prior art. For example, YAl₃(BO₃)₄ NLO crystals are disclosed in Pu Wang ET AL., Growth And Evaluation Of Ytterbium-Doped Yttrium Aluminum Borate as a Potential Self-Doubling Laser Crystal, J. OF THE OPTICAL SOC. OF AM. B, January 1999, at 63-69, which is incorporated herein by reference. NLO crystals, such as YAl₃(BO₃)₄ NLO crystals, have been used in a variety of devices. For example, U.S. Pat. No. 5,202,891 describes a neodymium yttrium aluminum borate NLO crystal incorporated into a laser device. U.S. Pat. No. 4,826,283 describes another NLO device made from single crystals of LiB₃O₅.

It is known to recrystallize NLO materials to form larger crystals with uniform crystal structures. For example, J. Li ET AL. disclose the formation of YAl₃(BO₃)₄ NLO crystals from a flux containing K₂MoO₄. See J. Li ET AL., The Influence of Yb³⁺ Concentration on Yb:YAl₃(BO₃)₄, 38 CRYS. RES. TECH. 890-895 (2003), which is incorporated herein by reference. Aluminum-borate NLO crystals grown with conventional techniques are generally limited to the generation or emission of light at wavelengths greater than 370 nm.

Hence, it is highly desirable to improve techniques for optical compounds.

### BRIEF SUMMARY OF THE INVENTION

The present invention relates generally to certain compounds having optical properties. More particularly, as an example, the invention provides a specific compound comprising AₓM₍₁₋ₓ₎Al₃B₄O₁₂ for use with selected wavelengths of electromagnetic radiation. x is larger than or equal to zero and smaller than or equal to 0.1, A is selected from a group consisting of Sc, Y, La, Yb, and Lu, and M is selected from a group consisting of Sc, Y, La, Yb, and Lu. Merely by way of example, the compound is useful for electromagnetic radiation having a wavelength of 350 nm and less, but it would be recognized that the invention has a much broader range of applicability.

According to one embodiment of the present invention, a compound for non-linear optics for use at 350 nm and below is provided. The compound includes a material for non-linear optics comprising YAl₃B₄O₁₂. The compound is free from a molybdenum-bearing impurity of at least 1000 parts per million.

According to yet another embodiment of the present invention, a compound for non-linear optics for use at 350 nm and below comprising a material for non-linear optics includes Y₍₁₋ₓ₎MₓAl₃B₄O₁₂. x is larger than or equal to zero and smaller than or equal to 0.1, and M is selected from a group consisting of Sc, La, Yb, and Lu. The compound is free from a molybdenum bearing impurity of at least 1000 parts per million.

According to yet another embodiment of the present invention, a compound for non-linear optics for use at 350 nm and below comprising a material for non-linear optics includes Yb₍₁₋ₓ₎MₓAl₃B₄O₁₂. x is larger than or equal to zero and smaller than or equal to 0.1, and M is selected from a group consisting of Sc, Y, La, and Lu. The compound is free from a molybdenum bearing impurity of at least 1000 parts per million.

According to yet another embodiment of the present invention, a compound for non-linear optics for use at 350 nm and below comprising a material for non-linear optics includes Lu₍₁₋ₓ₎MₓAl₃B₄O₁₂. x is larger than or equal to zero and smaller than or equal to 0.1, and M is selected from a group consisting of Sc, Y, Yb, and La. The compound is free from a molybdenum bearing impurity of at least 1000 parts per million.

According to yet another embodiment of the present invention, a compound for non-linear optics for use at 350 nm and below comprising a material for non-linear optics includes Sc₍₁₋ₓ₎MₓAl₃B₄O₁₂. x is larger than or equal to zero and smaller than or equal to 0.1, and M is selected from a group consisting of Y, La, Yb, and Lu. The compound is free from a molybdenum bearing impurity of at least 1000 parts per million.

According to yet another embodiment of the present invention, a compound for non-linear optics for use at 350 nm and below comprising a material for non-linear optics includes AₓM₍₁₋ₓ₎Al₃B₄O₁₂. x is larger than or equal to zero and smaller than or equal to 0.1, A is selected from a group consisting of Sc, Y, La, Yb, and Lu, and M is selected from a group consisting of Sc, Y, La, Yb, and Lu. The compound is free from a molybdenum bearing impurity of at least 1000 parts per million.

According to yet another embodiment of the present invention, a method for making a compound for non-linear optics for use at 350 nm and below includes providing a plurality of materials. The plurality of materials includes a lanthanum bearing compound, and the lanthanum bearing compound is capable of being decomposed into at least lanthanum oxide upon heating. Additionally, the method includes mixing the plurality of materials to form a mixture based on at least information associated with a predetermined proportion, starting a crystallization process in the mixture to form a crystal, and removing the crystal from the mixture, the crystal including lanthanum.

According to yet another embodiment of the present invention, a method for making a compound for non-linear optics for use at 350 nm and below includes providing a plurality of materials. The plurality of materials includes an yttrium bearing compound, and the yttrium bearing compound is capable of being decomposed into at least yttrium oxide upon heating. Additionally, the method includes mixing the plurality of materials to form a mixture based on at least information associated with a predetermined proportion, starting a crystallization process in the mixture to form a crystal, and removing the crystal from the mixture, the crystal including yttrium.

Many benefits are achieved by way of the present invention over conventional techniques. For example, some embodiments of the present invention provide new methods of preparation that exclude contaminants that preclude the operation of borate huntites in the ultraviolet spectrum. In addition, a preparative method has been developed to allow rapid formation of crystal by using an inventive chemical recipe. Such methods enable the manufacture of large single crystals of the present invention, heretofore unattained in conventional methods. Also, a preparative method has been developed with a lower volatility of the starting mixture when heated to a melting temperature than conventional methods.

According to certain embodiments of the present invention, described herein are nonlinear optical (NLO) crystals that have reduced concentrations of compounds that adversely affect the crystal's optical properties relative to known NLO crystals. These undesirable compounds are present to varying degrees in conventional NLO crystals, particularly conventional aluminum-borate NLO crystals. Some of the disclosed crystals are useful for modifying the wavelength of incident light, such as light emitted by a laser. For example, some of the disclosed crystals are capable of converting an input laser beam of a first wavelength into an output laser beam of a second wavelength, where the second wavelength is some integer value of the incident wavelength and is less than about 300 nm, typically less than about 250 nm, and even more typically less than about 175 nm.

Some of the disclosed crystals have volumes greater than about 0.1 mm³, typically greater than about 1 mm³, and even more typically greater than about 5 mm³. These crystals comprise a primary material and can also comprise one or more secondary materials different from the primary material. In some embodiments that contain secondary materials, any secondary materials that interfere with the generation and/or emission of light at desired wavelengths are present at low concentrations relative to their concentrations in conventional NLO crystals. For example, the secondary materials that interfere with the generation and/or emission of light at desired wavelengths can be present at concentrations of less than about 100 ppm by weight, typically less than about 50 ppm by weight, and even more typically less than about 10 ppm by weight. In other embodiments, the crystals are substantially free of secondary materials that interfere with the generation and/or emission of light at desired wavelengths. The secondary materials that interfere with the generation and/or emission of light at desired wavelengths can be, for example, compounds than contain transition-metal elements and/or lanthanides, other than yttrium, lanthanum, and lutetium. Some of these secondary materials, however, such as tungsten, are present in useful solvents and have a limited effect on the generation and/or emission of light at certain desired wavelengths. In some embodiments, the crystal comprises less than about 100 ppm by weight, typically less than about 50 ppm by weight, and even more typically less than about 10 ppm by weight of secondary materials that interfere with the generation and/or emission of light at desired wavelengths other than tungsten-containing compounds.

The aluminum-borate NLO crystals described include, but are not limited to, aluminum-borate NLO crystals that have chemical structures comprising yttrium, lutetium, or combinations thereof, such as YAl₃(BO₃)₄, LuAl₃(BO₃)₄, and Y₍₁₋ₓ₎LuₓAl₃(BO₃)₄, where x is an integer greater than zero. These materials, when crystallized to crystal sizes useful for optical applications, are new compounds in so far as undesired contaminants that interfere with the generation and/or emission of light at desired wavelengths are substantially reduced or substantially eliminated relative to known crystals.

Also described herein are embodiments of a method for making NLO crystals, particularly aluminum-borate NLO crystals. Some embodiments comprise providing a precursor materials and a solvent or a primary material and a solvent, where the solvent is substantially free of any materials that interfere with the generation and/or emission of light at desired wavelengths, and crystallizing the primary material to form a crystal that is substantially free of any materials that that interfere with the generation and/or emission of light at desired wavelengths. For example, the solvent and the crystal grown from the solvent can be substantially free of transition-metal elements and lanthanides, other than yttrium, lanthanum, and lutetium. As another example, the solvent and the crystal grown from the solvent can be substantially free of molybdenum.

Embodiments of the method can comprise mixing the precursor materials or primary material with the solvent to form a mixture and introducing a seed into the mixture. The seed, such as a crystalline primary material, perhaps consisting essentially of the primary material, can be suspended in the mixture. In some embodiments, recrystallizing the primary material comprises cooling the mixture and withdrawing the crystal from the mixture. Cooling the mixture can comprise cooling the mixture from a first temperature at or above a melting point of the mixture to a second temperature below the melting point of the mixture over a growing period sufficient to grow crystals of a desired size suitable for useful applications, such a growing period typically being longer than about 10 hours. During a portion of the growing period longer than about 2 hours, the mixture can be cooled at a cooling gradient of less than about 2° C. per hour. In some embodiments the second temperature can be, for example, a temperature between about 5° C. and about 100° C. less than the melting point of the mixture.

The embodiments of the method can be used to grow a variety of NLO crystals, particularly aluminum-borate NLO crystals, such as aluminum-borate NLO crystals that have chemical structures comprising yttrium, lutetium, or combinations thereof, such as YAl₃(BO₃)₄, LuAl₃(BO₃)₄, and Y₍₁₋ₓ₎LuₓAl₃(BO₃)₄, where x is an integer great Suitable solvents include solvents substantially free of materials that interfere with the generation and/or emission of light at desired wavelengths, including solvents that are substantially free of transition-metal elements and lanthanides, other than yttrium, lanthanum, and lutetium, and solvents that are substantially free of molybdenum. Examples of suitable solvents comprise one or more of the following compounds: LaB₃O₆, MgB₂O₄, and LiF. In some embodiments, the solvents are substantially free of transition-metal elements and lanthanides, other than yttrium, lanthanum, lutetium, and tungsten. An example of a tungsten-containing solvent is Li₂WO₄, which can be used, for example, with B₂O₃ to grow YAl₃(BO₃)₄ crystals.

The described NLO crystals can be incorporated into a variety of devices, including laser devices. These devices can be used, for example, to detect anomalies on the surface of a substrate or to bore holes in a substrate.

Various additional objects, features and advantages of the present invention can be more fully appreciated with reference to the detailed description and the accompanying drawings that follow.

### BRIEF DESCRIPTION OF THE DRAWINGS

FIG. 1 is a simplified method for making optical compound according to an embodiment of the present invention;

FIG. 2 is a simplified image for an optical compound according to an embodiment of the present invention;

FIG. 3 is a simplified diagram showing transmission characteristics for an optical compound according to an embodiment of the present invention;

FIG. 4 is a simplified diagram showing frequency conversion by an optical compound according to an embodiment of the present invention.

FIG. 5 is a line graph showing the percent transmittance of a YAl₃(BO₃)₄ crystal grown with tungsten (YAB—W), the percent transmittance of a YAl₃(BO₃)₄ crystal containing molybdenum (YAB—Mo), and the percent transmittance of a YAl₃(BO₃)₄ crystal that is substantially free of all transition-metal contaminants (YAB—La), over a wavelength range from 280 nm to 400 nm.

FIG. 6 is a schematic of a laser device that incorporates a NLO crystal.

### DETAILED DESCRIPTION OF THE INVENTION

The present invention relates generally to certain compounds having optical properties. More particularly, as an example, the invention provides a specific compound comprising AₓM₍₁₋ₓ₎Al₃B₄O₁₂ for use with selected wavelengths of electromagnetic radiation. x is larger than or equal to zero and smaller than or equal to 0.1, A is selected from a group consisting of Sc, Y, La, Yb, and Lu, and M is selected from a group consisting of Sc, Y, La, Yb, and Lu. Merely by way of example, the compound is useful for electromagnetic radiation having a wavelength of 350 nm and less, but it would be recognized that the invention has a much broader range of applicability.

NYAB was developed as a self-doubling crystal, i.e., a crystal that is optically pumped and generates the fundamental wavelength and its second harmonic without the need of a separate frequency doubling crystal. However, due to inherent limitations, the possible applications are drastically limited. First, the fundamental wavelength often can only be 1060 nm and 1300 nm. Second, since the crystals usually are only a few millimeters in size, they are often not available in adequately large crystal sizes convenient for commercial use in products.

While NYAB may have been made commercially available from time-to-time in limited quantities, the pure form of YAB has not been commercially produced. The conventional method of production yields small crystal that contains a significant amount of nonstoichiometric metals contamination and exhibits substandard crystal quality. Moreover, the fluxing agent(s) used in conventional methods introduce a considerable amount of contaminant that prevents effective device operation in the UV below 350 nm.

According to certain embodiments of the present invention, several kinds of borate crystals containing one or more kinds of metal ions of a rare earth metal and the like were prepared, and an occurrence experiment of double harmonic (wavelength: 266 nm) was carried out by irradiating frequency doubled Nd:YAG laser (wavelength: 532 nm) onto these borate crystals. Thereby, the ability to experimentally make NLO materials was demonstrated that produce harmonic light below 350 nm. As a result, strong generation of second harmonic 266 nm from borate crystals was found that includes both Y and Al, and a novel NLO crystal in the form of yttrium aluminum borate was achieved capable of transmitting and producing ultraviolet radiation below 350 nm.

It is an object of certain embodiments of the present invention to produce and utilize nonlinear optical materials that satisfy Y₍₁₋ₓ₎MₓAl₃B₄O₁₂, where M=Sc, La, Yb, or Lu, and 0≦x≦0.1, and manufactured by a method that eliminates or significantly reduces contaminants that prohibit device use in the UV spectrum. More specifically, some embodiments of the present invention substantially exclude metals, such as those of Group 6, from being present in the device so as to be useful in the UV below 350 nm.

It is an object of some embodiments of the present invention to provide methods for making nonlinear optical materials that satisfy the above composition without the deleterious UV absorption. One embodiment comprises forming a mixture comprising from about 10 to about 30 mol % of a source of Y, from about 10 to about 40 mol % of M, from about 15 to about 40 mol % of a source of Al, and from about 25 to about 50 mol % of boron oxide. If M is Sc, then the source of M generally is scandium oxide; if M is La, then the source of M generally is lanthanum oxide; if M is Yb, then the source of M generally is ytterbium oxide; if M is Lu, then the source of M generally is lutetium oxide. The mixture is heated to a temperature and for a period of time sufficient to form the NLO material. For instance, the step of heating may comprise heating the mixture to a first temperature of at least 850 K, and generally greater than about 850 K. The mixture is then cooled. After cooling the mixture is comminuted (ground to a fine powder, such as by grinding with a mortar and pestle), and then heated to a second temperature of at least 1300 K, generally greater than about 1300 K.

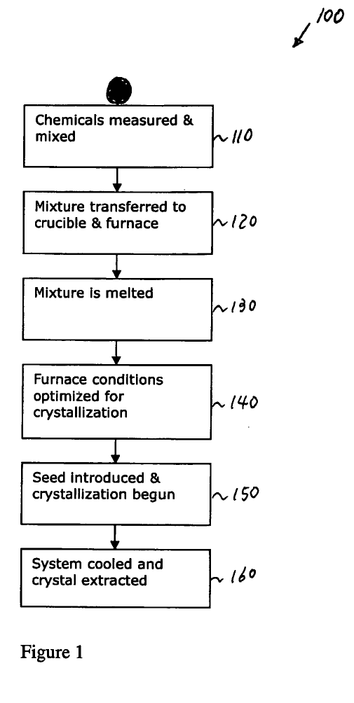

Another method to form these crystalline materials may be but not limited to top-seeded solution growth as shown in FIG. 1. The method includes the following processes:
1. High purity oxide powders and chemicals are measured and mixed in appropriate proportions.
2. The mixture is loaded in a crucible and placed in a furnace.
3. The mixture is heated and caused to melt into a liquid.
4. After a time, melt temperature is brought near to its freezing point.
5. A cold finger material or a seed crystal is introduced to initiate crystallization.
6. Melt temperature and apparatus conditions are modified and monitored to encourage crystal growth.
7. When appropriate, the system is brought down to room temperature.
8. The crystal is removed from the system.

For example, the synthesis of (Y,La)Al₃B₄O₁₂ may be performed as follows. Yttrium oxide (Y₂O₃), having a purity of greater than 99.9%, lanthanum oxide (La₂O₃), having a purity of greater than 99.9%, aluminum oxide (Al₂O₃), having a purity greater than 99.9%, and boron oxide (B₂O₃), having a purity of greater than 99.9% were purchased from commercial vendors such as Aesar and Stanford Materials. A mixture was formed including about 14 wt % yttrium oxide, about 30 wt % lanthanum oxide, about 19 wt % aluminum oxide, and about 37 wt % boron oxide.

As discussed above, certain embodiments of the present invention is related to nonlinear optical (NLO) devices and electrooptic devices and the ability to employ such devices below 350 nm. Some embodiments of the present invention are related to nonlinear optical materials that satisfy the general formula Y₍₁₋ₓ₎MₓAl₃B₄O₁₂ (M=Sc, La, or Lu and 0≦x≦0.1 mol %) and are prepared without contaminants that prevent use in the ultraviolet (UV) section of the electromagnetic spectrum.

According to some embodiments of the present invention, the nonlinear optical material Y₍₁₋ₓ₎MₓAl₃B₄O₁₂ (M=Sc, La, or Lu, and 0≦x≦0.1) is used for an NLO device for operation below 350 nm. In another example, the nonlinear optical material is used with a laser source for a device that generates optical radiation below 350 nm. In yet another example, the nonlinear optical material is used with a light source for a device that generates optical radiation below 350 nm. In yet another example, the nonlinear optical material is formed in the trigonal crystal class for use below 350 nm. In yet another example, the nonlinear optical material is formed in the space group R32 for use below 350 nm.

In certain embodiments of the present invention, the nonlinear optical material satisfies Yb₍₁₋ₓ₎MₓAl₃B4O₁₂ (M=Sc, La, or Lu, and 0≦x≦0.1) or Lu₍₁₋ₓ₎MₓAl₃B₄O₁₂ (M=Sc, La, or Lu, and 0≦x≦0.1). In some embodiments, the nonlinear optical material Y₍₁₋ₓ₎MₓAl₃B₄O₁₂, Yb₍₁₋ₓ₎MₓAl₃B₄O₁₂, or Lu₍₁₋ₓ₎MₓAl₃B₄O₁₂ is doped by Ce and/or Nd. In certain embodiments, the nonlinear optical material Y₍₁₋ₓ₎MₓAl₃B₄O₁₂ or Lu₍₁₋ₓ₎MₓAl₃B₄O₁₂ is doped by Ce, Nd, and/or Yb.

As discussed above, while NYAB may be available in limited quantities, the pure form of YAB has not been commercially produced. The conventional method of production yields small crystal that contains a large amount of nonstoichiometric metals contamination and exhibits substandard crystal quality. Moreover, the solvent used introduces a considerable amount of contaminant that prevents device operation in the UV below 350 nm. The summary of work on huntite borates by Leonyuk & Leonyuk (1995) described a flux system that has subsequently remained as a method of producing YAB and its family members, namely the potassium molybdates K₂MoO₄ and K₂Mo₃O₁₀. Unfortunately, these solvent formulations possess severe limitations for large scale crystal growth: a) high flux volatility, b) small crystal yield, and c) significant inclusion of Mo atoms into the target borate huntite structure. Thus, neither has commercial crystal production of pure YAB come about nor has the NLO crystal been adopted into laser products.

It is an object of certain embodiments of the present invention to produce and utilize nonlinear optical materials that satisfy AₓM₍₁₋ₓ₎Al₃B₄O₁₂ where 0≦x≦0.1, A=(Sc, Y, La, Yb, Lu), M=(Sc, Y, La, Yb, Lu), and manufactured by a method that eliminates or significantly reduces contaminants that prohibit device use in the UV spectrum. More specifically, some embodiments of the present invention substantially exclude metals, such as those of Group 6, from being present in the device so as to be useful in the UV below 350 nm. Avoiding the inclusion of Group 6 impurities, such as Mo, extends the UV transmission of select borate huntites. In addition, the absence of superfluous metals in the primary crystal composition reduces the overall bulk spectral absorption over its entire transparency range, such as from 165 to 2700 nm. With the embodiments described herein, the intrinsic transparency may be realized, heretofore unknown and uncharacterized in the scientific community.

As discussed above, it is an object of some embodiments of the present invention to provide methods for making nonlinear optical materials that satisfy AₓM₍₁₋ₓ₎Al₃B₄O₁₂ where 0≦x≦0.1, A=(Sc, Y, La, Yb, Lu), M=(Sc, Y, La, Yb, Lu) without the deleterious UV absorption. One embodiment comprises forming a mixture comprising from about 10 to about 30 mol % of a source of A, from about 10 to about 40 mol % of M, from about 15 to about 40 mol % of a source of Al, and from about 25 to about 50 mol % of boron oxide. If A or M is Sc, then the source of A or M generally is scandium oxide; if A or M is Y, then the source of A or M generally is yttrium oxide; if A or M is La, then the source of A or M generally is lanthanum oxide; if A or M is Yb, then the source of A or M generally is ytterbium oxide; if A or M is Lu, then the source of A or M generally is lutetium oxide. The mixture is heated to a temperature and for a period of time sufficient to form the NLO material. For instance, the step of heating may comprise heating the mixture to a first temperature of at least 850 K, and generally greater than about 850 K. The mixture is then cooled. After cooling the mixture is comminuted (ground to a fine powder, such as by grinding with a mortar and pestle), and then heated to a second temperature of at least 1300 K, generally greater than about 1300 K.

As discussed above, FIG. 1 is a simplified method for making optical compound according to an embodiment of the present invention. This diagram is merely an example, which should not unduly limit the scope of the claims. One of ordinary skill in the art would recognize many variations, alternatives, and modifications. The method 100 includes a process 110 for measuring and mixing chemicals, a process 120 for transferring mixture to crucible and furnace, a process 130 for melting mixture, a process 140 optimizing furnace conditions for crystallization, a process 150 for introducing seed and starting crystallization, and a process 160 for cooling system and extracting crystal. Although the above has been shown using a selected sequence of processes, there can be many alternatives, modifications, and variations. For example, some of the processes may be expanded and/or combined. Other processes may be inserted to those noted above. Depending upon the embodiment, the specific sequence of processes may be interchanged with others replaced. For example, the process 150 is modified to use spontaneous nucleation, or use conventional optical crystal growth procedures to introduce a cold finger to the melt surface. Further details of these processes are found throughout the present specification and more particularly below.

At the process 110, certain chemicals are measured and mixed. For example, high purity oxide powders and chemicals are measured and mixed in appropriate proportions. At the process 120, the mixture is transferred to crucible and furnace. For example, the mixture is loaded in a crucible and placed in a furnace. At the process 130, the mixture is melted. For example, the mixture is heated and caused to melt into a liquid.

At the process 140, furnace conditions are optimized for crystallization. For example, after a time, the melt temperature is brought near to its freezing point. At the process 150, a seed is introduced and the crystallization is started. For example, a seed crystal is introduced to initiate crystallization. In another example, the process 150 is modified to use a cold finger material to initiate crystallization. In yet another example, the process 150 is modified to use spontaneous nucleation to initiate crystallization. Additionally, the melt temperature and apparatus conditions are modified and monitored to encourage crystal growth. At the process 160, the system is cooled and the crystal is extracted. For example, when appropriate, the system is brought down to room temperature. The crystal is removed from the system and ready for tests or further processing.

As an example for the method 100, the synthesis of Y₍₁₋ₓ₎LaₓAl₃B₄O₁₂, where 0≦x≦0.1 is performed as follows:

At the process 110, yttrium oxide (Y₂O₃), having a purity of greater than 99.9%, lanthanum oxide (La₂O₃), having a purity of greater than 99.9%, aluminum oxide (Al₂O₃), having a purity greater than 99.9%, and boron oxide (B₂O₃), having a purity of greater than 99.9% are obtained. For example, these chemicals are acquired from commercial vendors such as Aesar and Stanford Materials. A mixture is formed including about 14 wt % Y₂O₃, about 30 wt % La₂O₃, about 19 wt % Al₂O₃, and about 37 wt % B₂O₃.

At the process 120, the mixture is loaded into a crucible and placed in a high-temperature furnace with atmospheric environment control. For example, either ambient or an inert atmosphere is satisfactory. At the process 130, the mixture is heated in 12 hours from room temperature to another temperature ranging from 1450 to 1575 K. The resulting melt is allowed to soak at another temperature for about 1 to 3 days.

At the process 140, the liquid mixture is cooled at a rate of 20 K/hour to a temperature near its freezing point. For example, the temperature ranges from about 1475 to 1400 K. At the temperature, the mixture is held for about 8 hours. At the process 150, by spontaneous nucleation, or by using conventional optical crystal growth procedures to introduce a crystalline seed or cold finger to the melt surface, the product begins to form while cooling to a final temperature of 1300 K at a rate of about 1-5 K/day. Additionally, during the course of the growth, the melt temperature and apparatus conditions are monitored and optionally modified to encourage crystal growth, either by an operator and/or by the automated control system on the furnace.

At the process 160, the system is then cooled to room temperature at a cooling rate of about 50 K/hour. Colorless, transparent crystal of Y₍₁₋ₓ₎LaₓAl₃B₄O₁₂, where 0≦x≦0.1, is obtained and removed from the furnace.

In yet another example for the method 100, the synthesis of Lu₍₁₋ₓ₎LaₓAl₃B₄O₁₂, where 0≦x≦0.1, is performed as follows:

At the process 110, lutetium oxide (Lu₂O₃), having a purity of greater than 99.9%, lanthanum oxide (La₂O₃), having a purity of greater than 99.9%, aluminum oxide (Al₂O₃), having a purity greater than 99.9%, and boron oxide (B₂O₃), having a purity of greater than 99.9% are obtained. For example, these chemicals are acquired from commercial vendors such as Aesar and Stanford Materials. A mixture is formed including about 21 wt % Lu₂O₃, about 30 wt % La₂O₃, about 16 wt % Al₂O₃, and about 34 wt % B₂O₃.

At the process 120, the mixture is loaded into a crucible and placed in a high-temperature furnace with atmospheric environment control of nitrogen with a partial pressure of oxygen, which is larger than or equal to 3000 ppm. At the process 130, the mixture is heated in 12 hours from room temperature to another temperature ranging from 1450 to 1575 K. The resulting melt is allowed to soak at another temperature for about 1 to 3 days.

At the process 140, the liquid mixture is cooled at a rate of 20 K/hour to a temperature near its freezing point. For example, the temperature ranges from about 1475 to 1400 K. At the temperature, the mixture is held for about 8 hours. At the process 150, by spontaneous nucleation, or by using conventional optical crystal growth procedures to introduce a crystalline seed or cold finger to the melt surface, the product begins to form while cooling to a final temperature of 1275 K at a rate of about 1-5 K/day. Additionally, during the course of the growth, the melt temperature and apparatus conditions are monitored and optionally modified to encourage crystal growth, either by an operator and/or by the automated control system on the furnace.

At the process 160, the system is then cooled to room temperature at a cooling rate of about 50 K/hour. Colorless, transparent crystal of Lu_{(1-x)La}ₓAl₃B₄O₁₂, where 0≦x≦0.1, is obtained and removed from the furnace.

In yet another example for the method 100, the synthesis of Sc₍₁₋ₓ₎LaₓAl₃B₄O₁₂, where 0≦x≦0.1, is performed as follows:

At the process 110, scandium oxide (Sc₂O₃), having a purity of greater than 99.9%, lanthanum oxide (La₂O₃), having a purity of greater than 99.9%, aluminum oxide (Al₂O₃), having a purity greater than 99.9%, and boron oxide (B₂O₃), having a purity of greater than 99.9% are obtained. For example, these chemicals are acquired from commercial vendors such as Aesar and Stanford Materials. A mixture is formed including about 8 wt % Sc₂O₃, about 34 wt % La₂O₃, about 18 wt % Al₂O₃, and about 39 wt % B₂O₃.

At the process 120, the mixture is loaded into a crucible and placed in a high-temperature furnace with atmospheric environment control. For example, either ambient or a nitrogen atmosphere is satisfactory. At the process 130, the mixture is heated in 12 hours from room temperature to another temperature ranging from 1475 to 1600 K. The resulting melt is allowed to soak at temperature for about 1 to 3 days.

At the process 140, the liquid mixture is cooled at a rate of 20 K/hour to a temperature near its freezing point. For example, the temperature ranges from about 1500 to 1425 K. At the temperature, the mixture is held for about 8 hours. At the process 150, by spontaneous nucleation, or by using conventional optical crystal growth procedures to introduce a crystalline seed or cold finger to the melt surface, the product begins to form while cooling to a final temperature of 1300 K at a rate of about 1-5 K/day. Additionally, during the course of the growth, the melt temperature and apparatus conditions are monitored and optionally modified to encourage crystal growth, either by an operator and/or by the automated control system on the furnace.

At the process 160, the system is then cooled to room temperature at a cooling rate of about 50 K/hour. Colorless, transparent crystal of Sc₍₁₋ₓ₎LaₓAl₃B₄O₁₂, where 0≦x≦0.1, is obtained and removed from the furnace.

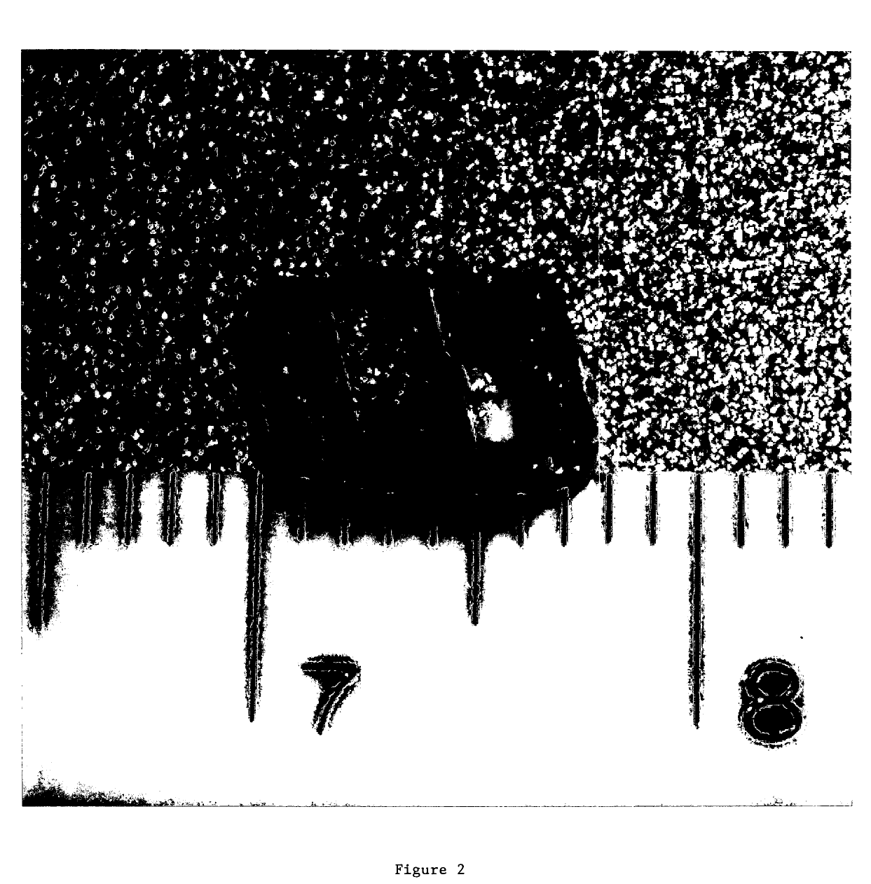

FIG. 2 is a simplified image for an optical compound according to an embodiment of the present invention. This diagram is merely an example, which should not unduly limit the scope of the claims. One of ordinary skill in the art would recognize many variations, alternatives, and modifications. The optical compound includes YₓLa_{y}Al₃B₄O₁₂, where 0≦x, 0≦y, and x+y≦1, made by the method 100 as discussed above. The synthesis starts with yttrium oxide (Y₂O₃), lanthanum oxide (La₂O₃), aluminum oxide (Al₂O₃), and boron oxide (B₂O₃). As shown in FIG. 2, the 6×6×7 mm crystal is sufficiently large and possesses optically-transparent faces that enable it to function in laser light modification device.

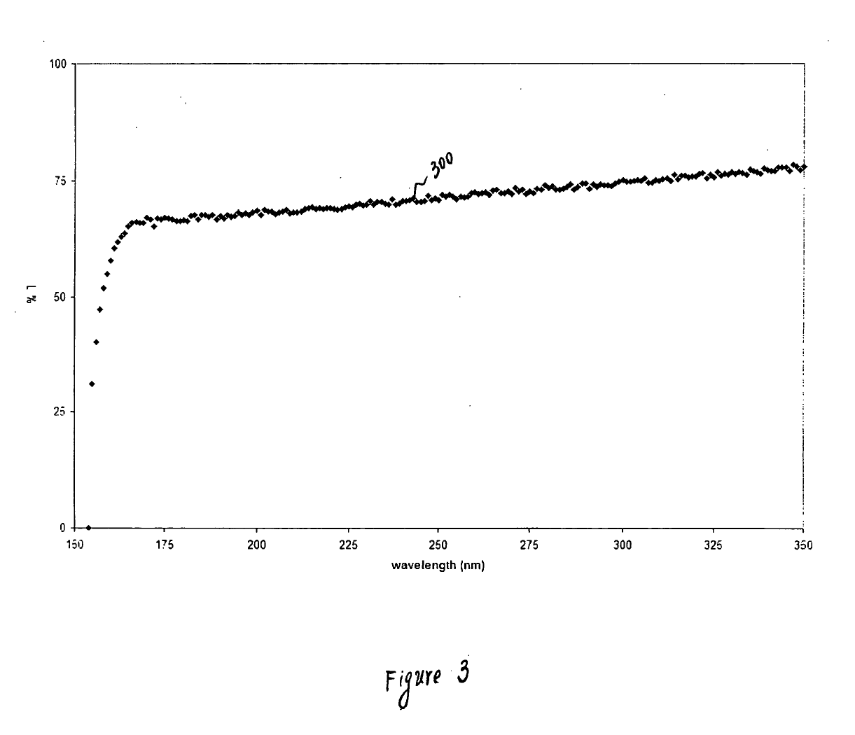

FIG. 3 is a simplified diagram showing transmission characteristics for an optical compound according to an embodiment of the present invention. This diagram is merely an example, which should not unduly limit the scope of the claims. One of ordinary skill in the art would recognize many variations, alternatives, and modifications. The optical compound includes Y₍₁₋ₓ₎LaₓAl₃B₄O₁₂, where 0≦x≦0.1, made by the method 100 as discussed above. The synthesis starts with yttrium oxide (Y₂O₃), lanthanum oxide (La₂O₃), aluminum oxide (Al₂O₃), and boron oxide (B₂O₃). As shown in FIG. 3, a curve 300 shows the transmission percentage as a function of wavelength. The transmission percentage remains relative constant from 350 nm to about 175 nm.

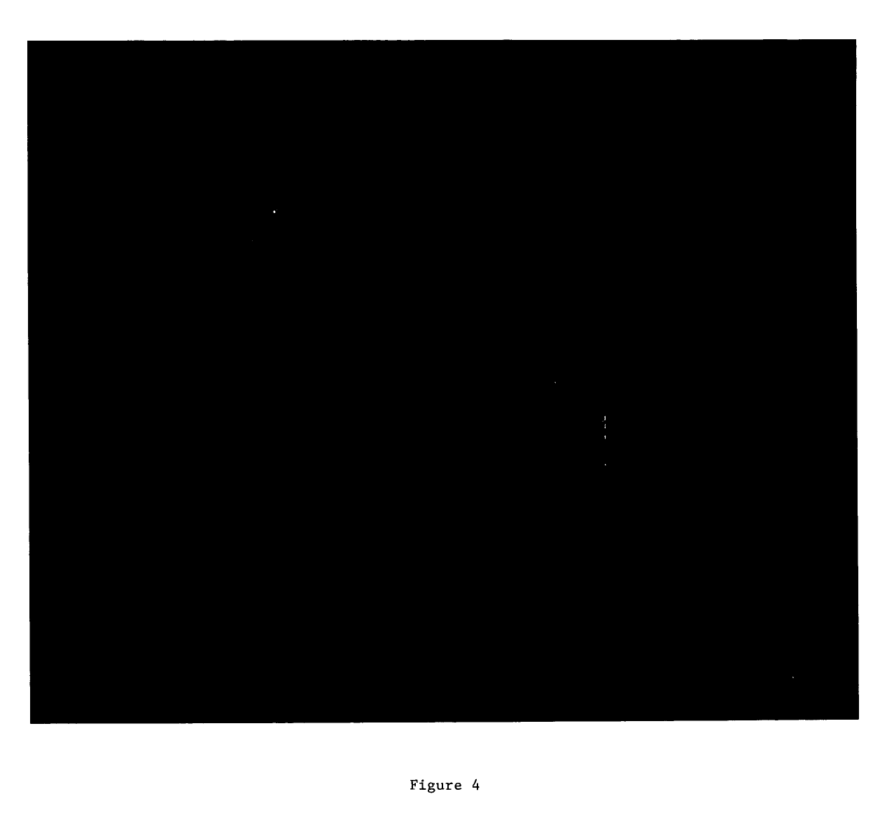

FIG. 4 is a simplified diagram showing frequency conversion by an optical compound according to an embodiment of the present invention. This diagram is merely an example, which should not unduly limit the scope of the claims. One of ordinary skill in the art would recognize many variations, alternatives, and modifications. The optical compound includes Y₍₁₋ₓ₎LaₓAl₃B₄O₁₂, where 0≦x≦0.1, made by the method 100 as discussed above. The synthesis starts with yttrium oxide (Y₂O₃), lanthanum oxide (La₂O₃), aluminum oxide (Al₂O₃), and boron oxide (B₂O₃). For example, the optical compound is the crystal as shown in FIG. 2. During the experiment, laser pulses with a wavelength of about 532 nm were delivered to a 6-mm-by-6-mm-by-7-mm Y₍₁₋ₓ₎LaₓAl₃B₄O₁₂ crystal. In response, the crystal output a light beam received by an imaging scintillator card, which was sensitive to ultraviolet radiation. As shown in FIG. 4, an image was taken using a camera that was made blind to 532 nm with a filter for the photograph. In the image, blue fluorescence was observed on the imaging scintillator card. Hence ultraviolet light was generated by the Y₍₁₋ₓ₎LaₓAl₃B₄O₁₂ crystal through a SHG process and was detected by the imaging scintillator card. In another experiment, a dichroic mirror was specifically optimized for 266-nm light transmission and placed between the Y₍₁₋ₓ₎LaₓAl₃B₄O₁₂ crystal and the imaging scintillator card. Blue fluorescence, which is similar to that in FIG. 4, was also observed. Hence ultraviolet light at 266 nm was generated by the Y₍₁₋ₓ₎LaₓAl₃B₄O₁₂ crystal.

As discussed above, and further emphasized here, the method can be used to make various types of optical compounds. According to one embodiment of the present invention, a compound for non-linear optics for use at 350 nm and below is made by the method 100. The compound includes a material for non-linear optics comprising YAl₃B₄O₁₂. The compound is free from a molybdenum bearing impurity of at least 1000 parts per million. According to yet another embodiment of the present invention, a compound for non-linear optics for use at 350 nm and below is made by the method 100. The compound comprising a material for non-linear optics includes Y₍₁₋ₓ₎MₓAl₃B₄O₁₂. x is larger than or equal to zero and smaller than or equal to 0.1, and M is selected from a group consisting of Sc, La, Yb, and Lu. The compound is free from a molybdenum bearing impurity of at least 1000 parts per million.

According to yet another embodiment of the present invention, a compound for non-linear optics for use at 350 nm and below is made by the method 100. The compound comprising a material for non-linear optics includes Yb₍₁₋ₓ₎MₓAl₃B₄O₁₂. x is larger than or equal to zero and smaller than or equal to 0.1, and M is selected from a group consisting of Sc, Y, La, and Lu. The compound is free from a molybdenum bearing impurity of at least 1000 parts per million. According to yet another embodiment of the present invention, a compound for non-linear optics for use at 350 nm and below is made by the method 100. The compound comprising a material for non-linear optics includes Lu₍₁₋ₓ₎MₓAl₃B₄O₁₂. x is larger than or equal to zero and smaller than or equal to 0.1, and M is selected from a group consisting of Sc, Y, Yb, and La. The compound is free from a molybdenum bearing impurity of at least 1000 parts per million. According to yet another embodiment of the present invention, a compound for non-linear optics for use at 350 nm and below comprising a material for non-linear optics includes Sc₍₁₋ₓ₎MₓAl₃B₄O₁₂. x is larger than or equal to zero and smaller than or equal to 0.1, and M is selected from a group consisting of Y, La, Yb, and Lu. The compound is free from a molybdenum bearing impurity of at least 1000 parts per million.

According to yet another embodiment of the present invention, a compound for non-linear optics for use at 350 nm and below is made by the method 100. The compound comprising a material for non-linear optics includes AₓM₍₁₋ₓ₎Al₃B₄O₁₂. x is larger than or equal to zero and smaller than or equal to 0. 1, A is selected from a group consisting of Sc, Y, La, Yb, and Lu, and M is selected from a group consisting of Sc, Y, La, Yb, and Lu. The compound is free from a molybdenum bearing impurity of at least 1000 parts per million. In one embodiment, M includes at least one selected from a group consisting of La, Lu, Sc, Y, and Yb. In another embodiment, A includes at least one selected from a group consisting of Sc, Y, La, Yb, and Lu.

As discussed above, according to certain embodiments, each of various types of optical compounds made by the method 100 is free from a molybdenum bearing impurity of at least 1000 parts per million. For example, the compound is free from a molybdenum bearing impurity of at least 500 parts per million. In another example, the compound is free from a molybdenum bearing impurity of at least 100 parts per million. In yet another example, the compound is free from a molybdenum bearing impurity of at least 10 parts per million. In yet another example, the compound is free from a molybdenum bearing impurity of at least 1 part per million. In yet another example, the compound is substantially free from a molybdenum bearing impurity. According to some embodiments of the present invention, each of various types of optical compounds made by the method 100 each is free from any impurity of at least 1000 parts per million that can prevent the compound from being used for non-linear optics at 350 nm and below. For example, the compound is free from any such impurity of at least 500 parts per million. In another example, the compound is free from any such impurity of at least 100 parts per million. In yet another example, the compound is free from any such impurity of at least 10 parts per million. In yet another example, the compound is free from any such impurity of at least 1 part per million. In yet another example, the compound is substantially free from any such impurity.

As discussed above, according to certain embodiments, each of various types of optical compounds made by the method 100 has a volume greater than about 0.001 mm³. For example, the compound has a volume greater than about 0.01 mm³. In another example, the compound has a volume greater than about 0.1 mm³. In yet another example, the compound has a volume greater than about 1 mm³.

According to some embodiments, various types of optical compounds made by the method 100 can be used for non-linear optics at 350 nm and below. For example, the use is associated with a wavelength ranging from about 350 nanometers to 160 nm. In another example, the use is associated with a wavelength ranging from about 350 nm to 170 nm. In yet another example, the use is associated with a device that generates optical radiation below 350 nm. In yet another example, the device comprises an NLO system, the compound associated with a laser system, and/or the compound associated with a light source.

According to certain embodiments, the method 100 can be used to make a compound for non-linear optics for use at 350 nm and below. For example, the compound is associated with the trigonal crystal class for use below 350 nm, and/or the space group R32 for use below 350 nm. In another example, the compound also includes dopant including at least one selected from a group consisting of Ce, Nd, and Yb. In one embodiment, the nonlinear optical material includes NYAB. In another embodiment, the nonlinear optical material includes Yb:YAB. In yet another embodiment, the nonlinear optical material includes Ce:YAB.

According to yet another embodiment of the present invention, a method for making a compound for non-linear optics for use at 350 nm and below includes providing a plurality of materials. The plurality of materials includes a lanthanum bearing compound, and the lanthanum bearing compound is capable of being decomposed into at least lanthanum oxide upon heating. Additionally, the method includes mixing the plurality of materials to form a mixture based on at least information associated with a predetermined proportion, starting a crystallization process in the mixture to form a crystal, and removing the crystal from the mixture, the crystal including lanthanum. For example, the plurality of materials comprises lanthanum oxide. In another example, the plurality of material further comprises boron oxide. In yet another example, the method further includes placing the mixture into a furnace. In yet another example, the method further includes heating the mixture to a first predetermined temperature, and cooling the mixture to a second predetermined temperature. In yet another example, the starting a crystallization process comprises inserting a crystalline seed to a melt surface. In yet another example, the crystal includes AₓM₍₁₋ₓ₎Al₃B₄O₁₂. x is larger than or equal to zero and smaller than or equal to 0.1, A is selected from a group consisting of Sc, Y, La, Yb, and Lu, and M is selected from a group consisting of Sc, Y, La, Yb, and Lu. In yet another example, the method is implemented according to the method 100.

According to yet another embodiment of the present invention, a method for making a compound for non-linear optics for use at 350 nm and below includes providing a plurality of materials. The plurality of materials includes an yttrium bearing compound, and the yttrium bearing compound is capable of being decomposed into at least yttrium oxide upon heating. Additionally, the method includes mixing the plurality of materials to form a mixture based on at least information associated with a predetermined proportion, starting a crystallization process in the mixture to form a crystal, and removing the crystal from the mixture, the crystal including yttrium. For example, the plurality of materials includes yttrium oxide. In another example, the plurality of material further includes boron oxide. In yet another example, the method further includes placing the mixture into a furnace. In yet another example, the method further includes heating the mixture to a first predetermined temperature, and cooling the mixture to a second predetermined temperature. In yet another example, the starting a crystallization process comprises inserting a crystalline seed to a melt surface. In yet another example, the crystal includes AₓM₍₁₋ₓ₎Al₃B₄O₁₂. x is larger than or equal to zero and smaller than or equal to 0. 1, A is selected from a group consisting of Sc, Y, La, Yb, and Lu, and M is selected from a group consisting of Sc, Y, La, Yb, and Lu. In yet another example, the method is implemented according to the method 100.

For the following additional embodiments of the present invention, the abbreviations as shown are used:

mm: millimeters

NLO: nonlinear optical

nm: nanometers

ppm: parts per million

SHG: second harmonic generation

Also for the following additional embodiments, the following definitions are provided solely to aid readers and are intended to be no narrower than the meaning of the terms as they would be understood by a person of ordinary skill in the art.

Aluminum-Borate NLO Crystal: A NLO crystal with a chemical formula that includes aluminum and borate. Examples of aluminum-borate NLO crystals include, aluminum-borate NLO crystals that have chemical structures comprising yttrium, lutetium, or combinations thereof, such as YAl₃(BO₃)₄LuAl₃(BO₃)₄, and Y₍₁₋ₓ₎LuₓAl₃(BO₃)₄, where x is an integer greater than zero.

Laser Beam: A beam of photons produced by a laser device. Laser beams can, for example, be substantially collimated, substantially monochromatic, and substantially coherent.

Molybdenum-Containing Compound: Elemental molybdenum or a compound with a chemical formula that includes molybdenum, such as molybdenum oxide.

Nonlinear Optical Crystal: A crystal that exhibits nonlinear polarization in response to light energy. These crystals comprise a primary material and can also comprise one or more secondary materials.

Primary Material: A crystalline compound having nonlinear optical properties. A primary material forms the bulk of the crystal lattice in a NLO crystal. Primary materials, as initially synthesized or isolated, typically exist in a powder form. The primary powder material must be recrystallized to form a NLO crystal of a suitable size and of a suitable purity for the generation and/or emission of light at a desired wavelength. Alternatively, the primary material can be formed from precursor materials during the crystallization process.

Precursor Material: A material that can be combined with other precursor materials to form a primary material. For example, Y₂O₃, B₂O₃, and Al₂O₃ are precursor materials for the formation of YAl₃(BO₃)₄.

Secondary Material: Elements or compounds contained in a NLO crystal other than the primary material. Secondary materials can be incorporated intentionally (such as dopants) or incorporated unintentionally (such as contaminants). Secondary materials can be constituents of the crystal lattice or can exist outside the crystal lattice.

Transition-Metal Containing Compound: Elemental transition metals, or compounds with chemical formulas that include a transition metal, such as transition metal oxides.

Tungsten-Containing Compound: Elemental tungsten, or a compound with a chemical formula that includes tungsten, such as tungsten oxide.

Disclosed embodiments concern nonlinear optical crystals, particularly nonlinear optical crystals having reduced amounts of certain contaminants relative to known nonlinear optical crystals, such as contaminants that interfere with the optical properties of the nonlinear optical crystals.

Described herein are embodiments of NLO crystals and embodiments of methods for making and using these crystals. The described embodiments are useful for a variety of applications including, but not limited to, laser applications.

All NLO crystals comprise a crystal lattice having at least a primary material. NLO crystals also can include one or more secondary materials. The primary material can, for example, be doped with various dopants to change the optical properties of the crystal. Examples of primary materials include, but are not limited to: YAl₃(BO₃)₄, LuAl₃(BO₃)₄, BaB₂O₄, BaAl₂B₂O₇, K₂Al₂B₂O₇, CaAl₂B₂O₇, SrAl₂B₂O₇, TiOPO₄, KTiOAsO₄, RbTiOPO₄, RbTiOAsO₄, CsTiOAsO₄, LiNbO₃, KNbO₃, AgGaS2, AgGaSe₂, KH₂PO₄, KD₂PO₄, NH₄PO₄, CsH₂AsO₄, CsD₂AsO₄, LiIO₃, and LiTaO₃. These NLO materials may be used alone or in combination.

Among the aluminum-borate NLO crystals, aluminum-borate NLO crystals that have chemical structures comprising yttrium, lutetium, or combinations thereof, such as YAl₃(BO₃)₄, LuAl₃(BO₃)₄, and Y₍₁₋ₓ₎LuₓAl₃(BO₃)₄, where x is an integer greater than zero, are especially well-suited for the generation and/or emission of light at wavelengths shorter than about 300 nm, typically shorter than about 250 nm, and even more typically shorter than about 175 nm.

The utility of NLO crystals, including aluminum-borate NLO crystals, is derived primarily from their optical properties. To achieve the desired optical properties, it is often necessary to grow a single crystal with a relatively continuous crystal structure and very few defects. Furthermore, most applications require that the single NLO crystal be a certain size, such as a size sufficient to make the crystal compatible with an optical device, for example, a laser. Some useful NLO crystals have a volume greater than about 0.1 mm³, typically greater than about 1 mm³, and even more typically greater than about 5 mm³.

Before primary materials are recrystallized to form single crystals of suitable size and purity, the primary material can exists in a powder form comprising amorphous material or very small crystals. The recrystallization process can begin with the primary material in power form or, alternatively, it can begin with precursor materials that can be combined to form the primary material. For example, it is possible to combine precursor materials with a solvent to form a mixture and then crystallize the primary material from that mixture. Useful precursor materials include oxides of each element in the chemical structure of a primary material. For example, for forming YAl₃(BO₃)₄, the precursor materials can include: Y₂O₃, B₂O₃, and Al₂O₃. These precursor materials are available commercially, for example, from Sigma-Aldrich (St. Louis, Mo.).

This disclosure describes embodiments of a method for growing useful NLO crystals, such as aluminum-borate NLO crystals, from precursor materials or primary materials that are not yet in a form suitable for NLO crystal applications, i.e., are in their raw form, such as in powder form. Some embodiments involve mixing precursor materials or a primary material with a solvent to form a mixture. This mixture is then cooled and a NLO crystal grows as the mixture cools. The solvent provides a medium in which the elemental components of the primary material can combine in crystal form. Without a solvent, many primary materials, including YAl₃(BO₃)₄ and LuAl₃(BO₃)₄, tend to decompose unevenly at high temperatures.

Solvents can be chosen to promote the crystallization process by promoting the solubility of the precursor materials. When the precursor materials are acidic, solubility is enhanced when the solvent is basic. Likewise, when the precursor materials are basic, solubility is enhanced when the solvent is acidic. The pH of the solvent can be adjusted to promote solubility, but extreme alkalinity or acidity may have a detrimental effect on crystal growth.

Conventionally, solvents were chosen solely for their effect on the crystallization process. Since the crystal separates from the solvent during the crystallization process, it was thought that the choice of solvent would have little or no effect on the crystals produced by the process. Surprisingly, it has been discovered that certain elements present in conventional solvents are incorporated into crystals grown from mixtures comprising these solvents. For example, YAl₃(BO₃)₄ crystals grown in K₂MoO₂ contain molybdenum oxide as a secondary material. It has also been discovered that some of these contaminants, although present in small quantities, can substantially affect the optical properties of the crystals grown from mixtures comprising these solvents. For example, these contaminants can interfere with the generation and/or emission of light at desired wavelengths. Conventional YAl₃(BO₃)₄ crystals contain contaminants that prevent the crystals from generating and/or emitting light at wavelengths less than 370 nm.

By growing crystals in a mixture free, or at lease substantially free, of certain contaminants, it is possible to produce crystals with improved optical properties. For example, it is possible to grow aluminum-borate crystals, such as YAl₃(BO₃)₄ and LuAl₃(BO₃)₄ crystals, that generate and/or emit laser light at short wavelengths unobtainable with conventional aluminum-borate crystals, such as wavelengths less than about 300 nm, typically wavelengths less than about 250 nm, and even more typically wavelengths less than about 175 nm.

Certain contaminants are more harmful to the optical properties of a NLO crystal than others. For example, some contaminants interfere with the generation and/or emission of light at short wavelengths, such as wavelengths less than about 300 nm, typically wavelengths less than about 250 nm, and even more typically wavelengths less than about 175 nm. Some contaminants prevent NLO crystals from absorbing light at short wavelengths and therefore inhibit frequency mixing processes at these short wavelengths. Some of the contaminants that are incorporated into crystals grown in conventional solvents are compounds than contain elements that exhibit a charge transfer transition in the ultraviolet portion of the electromagnetic spectrum. These compounds interfere with the generation and/or emission of light at ultraviolet wavelengths. For some applications, the detrimental contaminants include compounds that contain transition-metal elements and/or lanthanides, other than yttrium, lanthanum, and lutetium. Table 2 shows the concentration of different elements in a YAl₃(BO₃)₄ crystal grown with a conventional solvent. As shown, the YAl₃(BO₃)₄ crystal contains 250 ppm by weight of molybdenum.

TABLE 2
Composition of a YAl₃(BO₃)₄ Crystal Grown with a Conventional Solvent

| | ppm by | | ppm by | | ppm by |
|---|---|---|---|---|---|
| Element | weight | Element | weight | Element | weight |
| H | not tested | Zn | ≦2 | Pr | 0.11 |
| Li | 0.15 | Ga | ≦1 | Nd | ˜6000 |
| Be | <0.01 | Ge | <0.1 | Sm | 0.1 |
| B | major | As | 0.88 | Eu | 4.0 |
| C | not tested | Se | <0.5 | Gd | 3.0 |
| N | not tested | Br | <0.1 | Tb | 15 |
| O | major | Rb | <0.1 | Dy | 0.10 |
| F | <0.5 | Sr | 0.37 | Ho | 0.034 |
| Na | 3.0 | Y | major | Er | 0.089 |
| Mg | 5.0 | Zr | 1.1 | Tm | 0.42 |
| Al | major | Nb | 0.079 | Yb | <0.1 |
| Si | 15 | Mo | 250 | Lu | 0.37 |
| P | 0.17 | Ru | <0.1 | Hf | <0.1 |
| S | 4.0 | Rh | <0.1 | Ta | <10 |
| Cl | 8.0 | Pd | <0.1 | W* | 1.2 |
| K | 100 | Ag | <0.5 | Re | <0.1 |
| Ca | 6.0 | Cd | <0.5 | Os | <0.1 |
| Sc | <0.1 | In | <0.1 | Ir | <0.1 |
| Ti | 0.51 | Sn | <0.5 | Pt | 6.5 |
| V | ≦1 | Sb | <0.5 | Au | <1 |
| Cr | ≦5 | Te | <0.1 | Hg | <0.1 |
| Mn | 0.37 | I | <0.1 | Tl | <0.1 |
| Fe | 10 | Cs | <0.1 | Pb | <0.1 |
| Co | 0.064 | Ba | 0.29 | Bi | <0.1 |
| Ni | 0.78 | La | 170 | Th | <0.01 |
| Cu | 1.0 | Ce | 0.54 | U | <0.01 |

*Inhomogeneous

In some of the disclosed embodiments, special solvents are used in the crystallization process. These solvents can be substantially free of contaminants that can be incorporated in growing crystals and can change the optical properties of those crystals. For example, these solvents can be substantially free of all transition-metal elements and lanthanides, other than yttrium, lanthanum, and lutetium. In some embodiments, these solvents are substantially free of molybdenum-containing compounds. In some embodiments, the solvent comprises LaB₃O₆, MgB₂O₄, LiF, or combinations thereof. The solvents LaB₃O₆, MgB₂O₄, and LiF are particularly useful for forming YAl₃(BO₃)₄ crystals.

Table 3 shows the concentration of different elements in a YAl₃(BO₃)₄ crystal grown in a solvent substantially free of molybdenum. As shown, the YAl₃(BO₃)₄ crystal contains 0.15 ppm by weight of molybdenum.

TABLE 3
Composition of a YAl₃(BO₃)₄ Crystal Grown
with a Solvent Substantially Free of Molybdenum

| | ppm by | | ppm by | | ppm by |
|---|---|---|---|---|---|
| Element | weight | Element | weight | Element | weight |
| H | Not tested | Zn | ≦2 | Pr | 0.063 |
| Li | 57 | Ga | ≦1 | Nd | 0.15 |
| Be | <0.01 | Ge | <0.1 | Sm | <0.1 |
| B | major | As | <0.5 | Eu | <0.1 |
| C | Not tested | Se | <0.5 | Gd | 0.20 |
| N | Not tested | Br | <0.1 | Tb | 0.038 |
| O | major | Rb | <0.1 | Dy | 0.29 |
| F | <0.5 | Sr | 0.066 | Ho | 0.29 |
| Na | 6.0 | Y | major | Er | 0.23 |
| Mg | 3.0 | Zr | 0.41 | Tm | 0.013 |
| Al | major | Nb | 0.14 | Yb | 1.9 |
| Si | 75 | Mo | 0.15 | Lu | 0.083 |
| P | 0.81 | Ru | <0.1 | Hf | <0.1 |
| S | 16 | Rh | <0.1 | Ta | <10 |
| Cl | 20 | Pd | <0.1 | W | 0.55 |
| K | 4.0 | Ag | <0.5 | Re | <0.1 |
| Ca | 2.5 | Cd | <0.5 | Os | <0.1 |
| Sc | <0.1 | In | <0.1 | Ir | <0.1 |
| Ti | 0.65 | Sn | <0.5 | Pt | 1.5 |
| V | ≦1 | Sb | <0.5 | Au | <1 |
| Cr | ≦5 | Te | <0.1 | Hg | <0.1 |
| Mn | 0.28 | I | <0.1 | Tl | <0.1 |
| Fe | 10 | Cs | <0.1 | Pb | <0.1 |
| Co | <0.1 | Ba | 0.15 | Bi | <0.1 |
| Ni | 0.15 | La | major | Th | <0.01 |
| Cu | 0.50 | Ce | 0.56 | U | <0.01 |

Several crystal-growing techniques can be used in conjunction with the specially-selected solvents to produce NLO crystals with desirable properties. In some embodiments, the mixture formed by mixing the precursor materials and the solvent, or the primary material in its raw form and the solvent, is heated to a temperature above the melting point of the mixture. The melting point of the mixture varies depending on the type and quantity of the solvent and the type and quantity of the precursor materials or primary material. The melting point and other melt characteristics (such as melt viscosity and melt creeping) also can be varied by introducing various additives into the mixture. Some useful additives are alkali metal salts and alkaline-earth metal salts. These salts can be, for example, oxides, fluorides, or chlorides. The additives are selected so that they will not interfere with at least one, and perhaps plural desired optical properties of the crystal being formed. For example, additives for the formation of NLO crystals that are intended for second harmonic generation at short wavelengths are selected so that they will not prevent the crystal from absorbing light at these short wavelengths.

In some embodiments of the crystal-growing process, a seed is introduced into the melted mixture and the mixture is then cooled slowly from a first temperature to a second temperature. The seed is typically a small crystal of the primary material, often with a crystal structure of uniform orientation. In some embodiments, the seed is suspended in the melted mixture as the mixture is cooled from the first temperature to the second temperature. As the mixture cools, the primary material crystallizes. The crystallization can occur around the seed as a single crystal with a uniform crystal orientation matching the crystal orientation of the seed.

Most of the crystal growth occurs over a growing period during which the mixture is cooled from the first temperature to the second temperature. The first temperature can be a temperature around or above the melting point of the mixture. The second temperature can be a temperature less than the melting point of the mixture, for example, a temperature between about 5° C. and about 100° C. less than the melting point of the mixture. The duration of the growing period depends on the primary material, the solvents, and the size of the desired crystal. Typically, crystals will grow at a rate of about 0.2 to about 0.3 mm per hour. Suitable growing periods are typically longer than about 10 hours. During a portion of the growing period, such as a portion longer than about 2 hours, the mixture can be cooled at a cooling gradient of less than about 2° C. per hour.

Table 4 lists several examples of mixtures containing different combinations of YAl₃(BO₃)₄ (as the primary material) and solvents, along with key melt characteristics of the mixtures. For each mixture, Table 4 lists the melting point, the growing temperature range (i.e. the range between the first temperature and the second temperature), and an example of an appropriate growing period.

TABLE 4
Melt Characteristics for Several YAl₃(BO₃)₄ Mixtures

| | | Melting | Growing | Growing |
|---|---|---|---|---|
| | | Point | Temperature | Time |
| Mixture # | Mixture | (° C.) | Range (° C.) | (days) |
| 1 | YAl₃(BO₃)₄ + | 1085 | 1085-1060 | 15 |
| | 2LaB₃O₆ + LiF | | | |
| 2 | YAl₃(BO₃)₄ + | 1155 | 1155-1127 | 15 |
| | 2LaB₃O₆ | | | |
| 3 | YAl₃(BO₃)₄ + | 1170 | 1170-1150 | 15 |
| | 1.5LaB₃O₆ + LiF | | | |
| 4 | YAl₃(BO₃)₄ + | 1230 | 1230-1200 | 10 |
| | 1.5LaB₃O₆ | | | |
| 5 | YAl₃(BO₃)₄ + | 1130 | 1130-1110 | 10 |
| | LaB₃O₆ + 2MgB₂O₄ | | | |
| 6 | YAl₃(BO₃)₄ + | 1010 | 1010-920 | 30 |
| | 3Li₂WO₄ + 2B₂O₃ | | | |

Among the mixtures represented by Table 4, the crystals formed from mixtures 1-4 exhibited varying degrees of creeping. Crystals grown from mixture 5 exhibited less creeping.

Generally, for the growth of NLO crystals intended for SHG at short wavelengths, it is advantageous to select solvents that do not contain transition-metal elements and/or lanthanides, other than yttrium, lanthanum, and lutetium. However, some solvents containing transition metals are especially effective at promoting melt uniformity of the primary material. It is therefore appropriate, in certain cases, to weigh the potential interference with the crystal's optical properties caused by possible incorporation of the harmful element into the NLO crystal with the beneficial effect of the solvent containing the harmful element. Use of solvents containing transition metals is especially appropriate where the NLO crystal being grown from the solvent is not intended to be used for SHG at very short wavelengths. For example, for the growth of NLO crystals to be used for SHG at wavelengths greater than about 300 nm, a solvent comprising tungsten can be used in some embodiments of the crystal-growing process. One tungsten-containing solvent that is well-suited for the growth of YAl₃(BO₃)₄ crystals is Li₂WO₄, which can be used in conjunction with B₂O₃. Crystals grown from mixture 6 as recited in Table 4, which incorporates Li₂WO₄ and BO₃, were of particularly high quality.

Table 5 shows the concentration of different elements in a YAl₃(BO₃)₄ crystal grown from mixture 6 illustrated in Table 4. Tungsten was incorporated at 550 ppm by weight.

TABLE 5
Composition of a YAl₃(BO₃)₄ Crystal Grown with Li₂WO₄ and B₂O₃

| | ppm by | | ppm by | | ppm by |
|---|---|---|---|---|---|
| Element | weight | Element | weight | Element | weight |
| H | not tested | Zn | 1.5 | Pr | <0.1 |
| Li | 50 | Ga | 0.65 | Nd | <0.1 |
| Be | <0.01 | Ge | <0.5 | Sm | <0.1 |
| B | Major | As | <0.5 | Eu | <0.1 |
| C | not tested | Se | <0.1 | Gd | <0.1 |
| N | not tested | Br | <0.1 | Tb | <0.1 |
| O | not tested | Rb | <0.1 | Dy | <0.1 |
| F | <0.5 | Sr | not tested | Ho | <0.1 |
| Na | 20 | Y | major | Er | <0.1 |
| Mg | 7.5 | Zr | 0.067 | Tm | <0.1 |
| Al | major | Nb | <0.05 | Yb | <0.1 |
| Si | 50 | Mo | 0.15 | Lu | <0.1 |
| P | 1.0 | Ru | <0.1 | Hf | <0.1 |
| S | 5.0 | Rh | <0.1 | Ta | <5 |
| Cl | 50 | Pd | <0.1 | W | 550 |
| K | 0.90 | Ag | <0.5 | Re | <0.1 |
| Ca | 7.0 | Cd | <0.5 | Os | <0.1 |
| Sc | ≦0.5 | In | <0.1 | Ir | <0.1 |
| Ti | 0.75 | Sn | 0.30 | Pt | <0.5 |
| V | 0.55 | Sb | 0.30 | Au | <0.5 |
| Cr | 4.0 | Te | <0.5 | Hg | <0.1 |
| Mn | 0.055 | I | <0.1 | Tl | <0.1 |
| Fe | 9.0 | Cs | <0.1 | Pb | <0.1 |
| Co | <0.05 | Ba | <0.5 | Bi | <0.1 |
| Ni | 0.15 | La | not tested | Th | <0.01 |
| Cu | 0.60 | Ce | <0.1 | U | <0.01 |

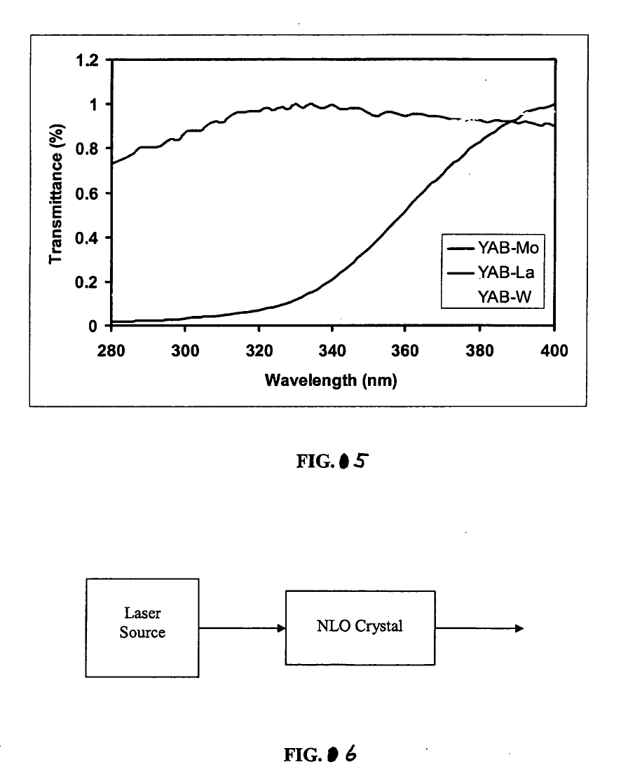

In evaluating the effect of tungsten on the optical properties of a NLO crystal grown with a tungsten solvent, it is helpful to consider FIG. 5. FIG. 5 illustrates the percent transmittance of a YAl₃(BO₃)₄ crystal grown with tungsten (YAB—W) compared to the percent transmittance of a YAl₃(BO₃)₄ crystal containing molybdenum (YAB—Mo) and the percent transmittance of a YAl₃(BO₃)₄ crystal that is substantially free of all transition-metal contaminants (YAB—La). As shown, the YAB—W crystal begins to absorb light at a wavelength that is longer than the wavelength at which the YAB—La crystal begins to absorb light, but shorter than the wavelength at which the YAB—Mo crystal begins to absorb light. For many applications, absorbance at shorter wavelengths is desirable. For these applications, the YAB—W crystal is preferable when compared to the YAB—Mo crystal, but still inferior to the YAB—La crystal.

After forming a crystal using the disclosed method, the uniform crystal structure can be verified by X-ray diffraction. The optical properties of the crystal can be tested by placing the crystal in a laser beam. For example, YAl₃(BO₃)₄ crystals can be tested in this manner to confirm the production of second-harmonic light.

NLO crystals formed by the disclosed method include NLO crystals, such as aluminum-borate NLO crystals, that are substantially free and/or contain less than about 100 ppm by weight, typically less than about 50 ppm by weight, and even more typically less than about 10 ppm by weight of any element that interferes with the generation and/or emission of light at desired wavelengths, such as wavelengths less than about 300 nm, typically less than about 250 nm, and even more typically less than about 175 nm. The secondary materials that interfere with the generation and/or emission of light at desired wavelengths can be, for example, transition-metal elements and lanthanides, other than yttrium, lanthanum, and lutetium. The crystals also can be classified by their concentration of molybdenum-containing compounds. Some crystals formed by the disclosed method are substantially free and/or contain less than about 100 ppm by weight, typically less than about 50 ppm by weight, and even more typically less than about 10 ppm by weight of any molybdenum-containing compound.

The crystals described in this disclosure have many useful applications. For example, aluminum-borate NLO crystals, such as aluminum-borate NLO crystals that have chemical structures comprising yttrium, lutetium, or combinations thereof, can be incorporated into laser devices, such as the laser device illustrated in FIG. 6. Under certain conditions, these crystals are capable of generating and/or emitting short wavelength laser beams.

Laser beams can be used to detect anomalies on the surface of substrates, including semiconductor substrates. This is done, for example, by directing the laser beam in a pattern over the surface of the substrate, such as a raster pattern, and measuring the consistency of the reflected light. When the laser beam encounters an anomaly on the surface of the substrate, such as a particle, the reflected light will scatter. Shorter wavelength laser beams are especially useful because they can detect smaller anomalies. This is important in the semiconductor industry, where, as the feature size decreases, the size of the anomalies that can adversely affect device function also decreases.

Shorter wavelength laser beams also can be used to bore small diameter holes in substrates. These laser beams concentrate more energy in a smaller area than longer wavelength laser beams and are therefore able to impart more energy to the substrate. The ability to bore small diameter holes in a substrate is useful, for example, in the construction of features on a printed circuit board.

For certain embodiments of the present invention, described are nonlinear optical (NLO) crystals, including aluminum-borate NLO crystals, that have low concentrations of contaminants that adversely affect the NLO crystal's optical properties, such as compounds that contain transition-metal elements and/or lanthanides, other than yttrium, lanthanum, and lutetium. Some NLO crystals with low concentrations of these contaminants are capable of second harmonic generation at very short wavelengths. Also described are embodiments of a method for making these NLO crystals. Some embodiments involve growing a single NLO crystal, such as an aluminum-borate NLO crystal, from a mixture containing a solvent that is substantially free of harmful contaminants. The described NLO crystals can be used, for example, in laser devices.

It is understood the examples and embodiments described herein are for illustrative purposes only and that various modifications or changes in light thereof will be suggested to persons skilled in the art and are to be included within the spirit and purview of this application and scope of the appended claims.

What is claimed is:

1. A compound for non-linear optics for use at 350 nm and below, the compound comprising a material for non-linear optics comprising YAl₃B₄O₁₂; wherein the compound is free from a molybdenum bearing impurity of at least 1000 parts per million.

2. The compound of claim 1 wherein the compound is free from a molybdenum bearing impurity of at least 500 parts per million.

3. The compound of claim 2 wherein the compound is free from a molybdenum bearing impurity of at least 100 parts per million.

4. The compound of claim 3 wherein the compound is free from a molybdenum bearing impurity of at least 10 parts per million.

5. The compound of claim 4 wherein the compound is free from a molybdenum bearing impurity of at least 1 part per million.

6. The compound of claim 5 wherein the compound is substantially free from a molybdenum bearing impurity.

7. The compound of claim 1 wherein the use is associated with a wavelength ranging from about 350 nanometers to 160 nm.

8. The compound of claim 1 wherein the use is associated with a device that generates optical radiation below 350 nm.

9. The compound of claim 8 wherein the device comprises an NLO system.

10. The compound of claim 8 wherein the device comprises the compound associated with a laser system.

11. The compound of claim 8 wherein the device comprises the compound associated with a light source.

12. The compound of claim 1 wherein the compound is associated with the trigonal crystal class for use below 350 nm.

13. The compound of claim 1 wherein the compound is associated with the space group R32 for use below 350 nm.

14. The compound of claim 1, and further comprising a dopant including at least one selected from a group consisting of Ce, Nd, and Yb.

15. The compound of claim 14 wherein the compound comprises NYAB.

16. The compound of claim 14 wherein the compound comprises Yb:YAB.

17. The compound of claim 14 wherein the compound comprises Ce:YAB.

18. The compound of claim 1 wherein the compound has a volume greater than about 0.001 mm³.

19. The compound of claim 18 wherein the compound has a volume greater than about 0.01 mm³.

20. The compound of claim 19 wherein the compound has a volume greater than about 0.1 mm³.

21. The compound of claim 20 wherein the compound has a volume greater than about 1 mm³.

22. A compound for non-linear optics for use at 350 nm and below, the compound comprising a material for non-linear optics comprising Y₍₁₋ₓ₎MₓAl₃B₄O₁₂, x larger than or equal to zero and smaller than or equal to 0.1, M selected from a group consisting of Sc, La, Yb, and Lu; wherein the compound is free from a molybdenum bearing impurity of at least 1000 parts per million.

23. A compound for non-linear optics for use at 350 nm and below, the compound comprising a material for non-linear optics comprising Yb₍₁₋ₓ₎MₓAl₃B₄O₁₂, x larger than or equal to zero and smaller than or equal to 0.1, M selected from a group consisting of Sc, Y, La, and Lu; wherein the compound is free from a molybdenum bearing impurity of at least 1000 parts per million.

24. A compound for non-linear optics for use at 350 nm and below, the compound comprising a material for non-linear optics comprising Lu₍₁₋ₓ₎MₓAl₃B₄O₁₂, x larger than or equal to zero and smaller than or equal to 0.1, M selected from a group consisting of Sc, Yb, and La; wherein the compound is free from a molybdenum bearing impurity of at least 1000 parts per million.

25. A compound for non-linear optics for use at 350 nm and below, the compound comprising a material for non-linear optics comprising Sc₍₁₋ₓ₎MₓAl₃B₄O₁₂, x larger than or equal to zero and smaller than or equal to 0.1, M selected from a group consisting of Y, La, Yb, and Lu; wherein the compound is free from a molybdenum bearing impurity of at least 1000 parts per million.

26. A compound for non-linear optics for use at 350 nm and below, the compound comprising:
a material for non-linear optics comprising AₓM₍₁₋ₓ₎Al₃B₄O₁₂; x is larger than or equal to zero and smaller than or equal to 0.1;
wherein:
A is selected from a group consisting of Sc, Y, La, Yb, and Lu;
M is selected from a group consisting of Sc, Y, La, Yb, and Lu;
the compound is free from a molybdenum bearing impurity of at least 1000 parts per million.

27. The compound of claim 26 wherein M is La.

28. The compound of claim 26 wherein M is Lu.

29. The compound of claim 26 wherein M is Sc.

30. The compound of claim 26 wherein M is Y.

31. The compound of claim 26 wherein M is Yb.

32. The compound of claim 26 wherein A is Sc.

33. The compound of claim 26 wherein A is Y.

34. The compound of claim 26 wherein A is La.

35. The compound of claim 26 wherein A is Yb.

36. The compound of claim 26 wherein A is Lu.

37. The compound of claim 26 wherein the compound is free from a molybdenum bearing impurity of at least 500 parts per million.

38. The compound of claim 37 wherein the compound is free from a molybdenum bearing impurity of at least 100 parts per million.

39. The compound of claim 38 wherein the compound is free from a molybdenum bearing impurity of at least 10 parts per million.

40. The compound of claim 39 wherein the compound is free from a molybdenum bearing impurity of at least 1 part per million.

41. The compound of claim 40 wherein the compound is substantially free from a molybdenum bearing impurity.

42. The compound of claim 26 wherein the use is associated with a wavelength ranging from about 350 nanometers to 160 nm.

43. The compound of claim 26 wherein the use is associated with a device that generates optical radiation below 350 nm.

44. The compound of claim 43 wherein the device comprises an NLO system.

45. The compound of claim 43 wherein the device comprises the compound associated with a laser system.

46. The compound of claim 43 wherein the device comprises the compound associated with a light source.

47. The compound of claim 26 wherein the compound is associated with the trigonal crystal class for use below 350 nm.

48. The compound of claim 26 wherein the compound is associated with the space group R32 for use below 350 nm.

49. The compound of claim 26, and further comprising a dopant including at least one selected from a group consisting of Ce and Nd.

50. The compound of claim 26 wherein the use is associated with a wavelength ranging from about 350 nm to 160 nm.

51. The compound of claim 26 wherein the compound has a volume greater than about 0.001 mm³.

52. The compound of claim 51 wherein the compound has a volume greater than about 0.01 mm³.

53. The compound of claim 52 wherein the compound has a volume greater than about 0.1 mm³.

54. The compound of claim 53 wherein the compound has a volume greater than about 1 mm³.

55. A nonlinear optical crystal with a volume greater than about 0.1 mm³ comprising less than about 100 ppm by weight of any element that inhibits the ability of the nonlinear optical crystal to generate and/or emit light at wavelengths less than about 300 nm.

56. The nonlinear optical crystal of claim 55, where the nonlinear optical crystal is an aluminum-borate nonlinear optical crystal.

57. The nonlinear optical crystal of claim 55, where the nonlinear optical crystal is an aluminum-borate nonlinear optical crystal comprising yttrium and/or lutetium.

58. An aluminum-borate nonlinear optical crystal with a volume greater than about 0.1 mm³ comprising less than about 100 ppm by weight of any compound containing a transition-metal element and/or a lanthanide, other than yttrium, lanthanum, and lutetium.

59. The aluminum-borate nonlinear optical crystal of claim 58, with a volume greater than about 1 mm³.

60. An aluminum-borate nonlinear nonlinear optical crystal with a volume greater than about 0.1 mm³ comprising less than about 100 ppm by weight of any single molybdenum-containing compound.

61. A YAl₃(BO₃)₄ crystal with a volume greater than about 0.1 mm³ comprising less than about 100 ppm by weight of any element that inhibits the ability of the YAl₃(BO₃)₄ crystal to generate and/or emit light at wavelengths less than about 300 nm.

62. A nonlinear optical crystal comprising a primary material and less than about 100 ppm by weight of any element that inhibits the ability of the nonlinear optical crystal to generate and/or emit light at wavelengths less than about 300 nm, where the nonlinear optical crystal is useful for modifying the wavelength of a laser beam generated by a laser device.

63. The nonlinear optical crystal of claim 62, where the nonlinear optical crystal is an aluminum-borate nonlinear optical crystal.

64. The nonlinear optical crystal of claim 62, where the nonlinear optical crystal is a YAl₃(BO₃)₄ crystal.

65. An aluminum-borate nonlinear optical crystal with a volume greater than about 1 mm³ that is capable of converting an input laser beam of a first wavelength into an output laser beam of a second wavelength, where the second wavelength is less than about 200 nm.

66. The aluminum-borate nonlinear optical crystal of claim 65, where the aluminum-borate nonlinear optical crystal is a YAl₃(BO₃)₄ crystal.

67. An aluminum-borate nonlinear optical crystal with a volume greater than about 1 mm³, where the aluminum-borate nonlinear optical crystal is capable of converting an input laser beam of a first wavelength into an output laser beam of a second wavelength, the second wavelength is less than about 500 nm, and the aluminum-borate nonlinear optical crystal comprises a tungsten-containing compound other than the primary material.

68. A method for making a nonlinear optical crystal, comprising:
providing a primary material and a solvent, where the solvent is substantially free of any element that inhibits the ability of the nonlinear optical crystal to generate and/or emit light at wavelengths less than about 300 nm; and
recrystallizing the primary material to form a nonlinear optical crystal that is substantially free of any element that inhibits the ability of the nonlinear optical crystal to generate and/or emit light at wavelengths less than about 300 nm.

69. A method for making an aluminum-borate nonlinear optical crystal, comprising:
providing a primary material and a solvent, where the solvent is substantially free of any element that inhibits the ability of the nonlinear optical crystal to generate and/or emit light at wavelengths less than about 300 nm; and
recrystallizing the primary material to form an aluminum-borate nonlinear optical crystal that is substantially free of any element that inhibits the ability of the nonlinear optical crystal to generate and/or emit light at wavelengths less than about 300 nm.

70. The method of claim 69, where the solvent comprises LaB₃O₆, MgB₂O₄, LiF, or combinations thereof.

71. The method of claim 69, where the solvent is substantially free of any single molybdenum-containing compound.

72. The method of claim 69, where the primary material is YAl₃(BO₃)₄.

73. The method of claim 72, where the solvent comprises LaB₃O₆.

74. The method of claim 69, where the primary material is LuAl₃(BO₃)₄.

75. The method of claim 74, where the solvent comprises LaB₃O₆.

76. The method of claim 69, where recrystallizing the primary material comprises mixing the primary material with a solvent to form a mixture and introducing a seed into the mixture.

77. The method of claim 76, where the seed consists essentially of the primary material.

78. The method of claim 76, where introducing a seed into the mixture comprises suspending the seed in the mixture.

79. The method of claim 76, where recrystallizing the primary material further comprises cooling the mixture and withdrawing the aluminum-borate nonlinear optical crystal from the mixture.

80. The method of claim 79, where cooling the mixture comprises cooling the mixture from a first temperature at or above a melting point of the mixture to a second temperature below the melting point of the mixture over a growing period, and the growing period is longer than about 10 hours.

81. The method of claim 80, where the second temperature is between about 5° C. and about 100° C. less than the melting point of the mixture.

82. The method of claim 80, where mixture is cooled at a cooling gradient of less than about 2° C. per hour during a portion of the growing period, and the portion of the growing period is longer than about 2 hours.

83. A method for making a YAl₃(BO₃)₄ crystal, comprising:
mixing YAl₃(BO₃)₄ with a solvent to form a mixture, where the solvent is substantially free of any compound containing a transition-metal element and/or a lanthanide, other than yttrium, lanthanum, and lutetium;
introducing a seed into the mixture;
cooling the mixture from a first temperature at or above a melting point of the mixture to a second temperature below the melting point of the mixture over a growing period; and
withdrawing the YAl₃(BO₃)₄ crystal from the mixture after cooling the mixture, where the growing period is longer than about 10 hours.

84. The method of claim 83, where the solvent comprises LaB₃O₆, MgB₂O₄, LiF, or combinations thereof.

85. A method for making an aluminum-borate nonlinear optical crystal, comprising:
providing a primary material and a solvent, where the solvent comprises tungsten; and
recrystallizing the primary material to form an aluminum-borate nonlinear optical crystal that is substantially free of any compound containing a transition-metal element and/or a lanthanide, other than yttrium, lanthanum, lutetium, and tungsten.

86. The method of claim 85, where the primary material is YAl₃(BO₃)₄.

87. The method of claim 86, where the solvent comprises Li₂WO₄.

88. The method of claim 87, where the solvent further comprises B₂O₃.

89. A method for making a YAl₃(BO₃)₄ crystal, comprising:
providing a YAl₃(BO₃)₄ and a solvent, where the solvent is substantially free of any single molybdenum-containing compound; and
recrystallizing the YAl₃(BO₃)₄ to form a YAl₃(BO₃)₄ crystal that comprises less than about 10 ppm by weight as molybdenum of any single molybdenum-containing compound.

90. A method for making a compound for non-linear optics for use at 350 nm and below, the method comprising:
providing a plurality of materials, the plurality of materials including a lanthanum bearing compound, the lanthanum bearing compound capable of being decomposed into at least lanthanum oxide upon heating;
mixing the plurality of materials to form a mixture based on at least information associated with a predetermined proportion;
starting a crystallization process in the mixture to form a crystal;
removing the crystal from the mixture, the crystal including lanthanum.

91. The method of claim 90 wherein the plurality of materials comprises lanthanum oxide.

92. The method of claim 91 wherein the plurality of material further comprises boron oxide.

93. The method of claim 90, and further comprising placing the mixture into a furnace.

94. The method of claim 90, and further comprising:
heating the mixture to a first predetermined temperature;
cooling the mixture to a second predetermined temperature.

95. The method of claim 90, wherein the starting a crystallization process comprises inserting a crystalline seed to a melt surface.

96. The method of claim 90 wherein:
the crystal comprises AₓM₍₁₋ₓ₎Al₃B₄O₁₂;
x is larger than or equal to zero and smaller than or equal to 0.1;
A is selected from a group consisting of Sc, Y, La, Yb, and Lu;
M is selected from a group consisting of Sc, Y, La, Yb, and Lu.

97. A method for making a compound for non-linear optics for use at 350 nm and below, the method comprising:
providing a plurality of materials, the plurality of materials including an yttrium bearing compound, the yttrium bearing compound capable of being decomposed into at least yttrium oxide upon heating;
mixing the plurality of materials to form a mixture based on at least information associated with a predetermined proportion;
starting a crystallization process in the mixture to form a crystal;
removing the crystal from the mixture, the crystal including yttrium.

98. The method of claim 97 wherein the plurality of materials comprises yttrium oxide.

99. The method of claim 98 wherein the plurality of material further comprises boron oxide.

100. The method of claim 97, and further comprising placing the mixture into a furnace.

101. The method of claim 97, and further comprising:
heating the mixture to a first predetermined temperature;
cooling the mixture to a second predetermined temperature.

102. The method of claim 97, wherein the starting a crystallization process comprises inserting a crystalline seed to a melt surface.

103. The method of claim 97 wherein:
the crystal comprises AₓM₍₁₋ₓ₎Al₃B₄O₁₂;
x is larger than or equal to zero and smaller than or equal to 0.1;
A is selected from a group consisting of Sc, Y, La, Yb, and Lu;
M is selected from a group consisting of Sc, Y, La, Yb, and Lu.
